(19) United States
(12) Patent Application Publication
(10) Pub. No.: US 2026/0264156 A1
(43) Pub. Date: Sep. 10, 2026

(54) AUTOMATED FERROUS CUTTING SAW AND LINEAR POSITIONING SYSTEM

(71) Applicant: Precision Automation, Inc., Vancouver, WA (US)

(72) Inventors: Nathan Yasuda, Portland, OR (US); Minh Dat Ba Tran, Vancouver, WA (US); Casey Bolthouse, Portland, OR (US); Michael Hojnacki, Portland, OR (US)

(73) Assignee: Precision Automation, Inc., Vancouver, WA (US)

(21) Appl. No.: 19/073,807

(22) Filed: Mar. 7, 2025

(51) Int. Cl. B23D 59/00; B23D 47/02; B23D 47/04; B23D 59/02; B23Q 11/00; B23Q 11/08

(52) U.S. Cl. CPC B23D 59/001; B23D 47/025; B23D 47/042; B23D 59/02; B23Q 11/0092; B23Q 11/0891

(57) ABSTRACT

In one aspect, a cold saw system can include a saw cabinet mounted on a saw table. The saw cabinet can include an aperture in a top surface thereof. The system can include a damper extending through the aperture, a circular saw coupled to the damper and disposed within the saw cabinet, a clamp configured to releasably engage a workpiece disposed on the table surface, and a controller storing instructions in non-transitory memory that, when executed, cause the controller to engage the workpiece with the clamp, advance the circular saw from a resting position to a cutting position, retract the circular saw from the cutting position to the resting position, and disengage the clamp. In some aspects, the circular saw can advance at a first rate between the resting position and a damper activation position, and advances at a second rate between the damper activation and cutting positions.

### FIELD

The present disclosure relates to cutting saws, specifically to automatic cold saws for cutting ferrous metals.

### BACKGROUND

A cold saw is a type of cutting saw configured to make a cut in a workpiece. As the cold saw cuts into the workpiece, the cold saw generates chips and transfers heat generated by the cutting action to the chips. By transferring the generated heat to the chips rather than to the cutting surface of the workpiece, cold saws can reduce heat buildup in the workpiece, thereby reducing the occurrence of material discoloration, burr formation, dust generation, and spark generation as compared to other types of cutting saws (e.g., abrasive saws). Thus, in these ways, cold saws can produce accurate cuts with high-quality finishes.

Accordingly, there is a pressing need for improved cold saws.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, a system can include a saw table defining a table surface; a saw cabinet mounted on the saw table, wherein the saw cabinet can include a top surface and an aperture in the top surface; a damper extending at least partially through the aperture; a circular saw coupled to the damper and disposed within the saw cabinet; a clamp configured to releasably engage a workpiece disposed on the table surface of the saw table; at least one of an infeed table defining an infeed table surface, wherein the infeed table surface can be coplanar with the table surface of the saw table, and an outfeed table defining an outfeed table surface, wherein the outfeed table surface can be coplanar with the table surface of the saw table; and a controller storing instructions in non-transitory memory that, when executed, can cause the controller to: engage the clamp; advance the circular saw from a resting position to a cutting position; retract the circular saw from the cutting position to the resting position; and disengage the clamp.

In one aspect, a system can include a saw table defining a table surface; a saw cabinet coupled to the saw table; a damper coupled to the saw cabinet; a circular saw coupled to the damper and disposed within the saw cabinet; and a controller storing instructions in non-transitory memory that, when executed, can cause the controller to: advance the circular saw from a resting position to a damper activation position; and advance the circular saw from the damper activation position to a cutting position.

In one aspect, a system can include a saw table defining a table surface; a saw cabinet coupled to the saw table; a damper coupled to the saw cabinet; a circular saw coupled to the damper and disposed within the saw cabinet; and a controller storing instructions in non-transitory memory that, when executed, can cause the controller to: advance the circular saw from a resting position to an intermediate position at a first rate; advance the circular saw from the intermediate position to a cutting position at a second rate; and retract the circular saw from the cutting position to the resting position.

In one aspect, a cold saw system can be an integrated system including a circular saw, a damper, an infeed table, an outfeed table, and a controller co-operating with each other. One or more cutting actions performed by the circular saw and the damper can be coordinated by the controller with one or more material handling actions performed by a push feeder on the infeed table and/or outfeed table. For example, the push feeder can advance along a length of the infeed table and position a stock piece accurately to prescribed lengths with repeatable tight tolerances, and the circular saw can make cuts at the prescribed lengths.

### BRIEF DESCRIPTION OF THE DRAWINGS

FIG. 1A is a perspective view of a cold saw system, according to an example.

FIG. 1B is a second perspective view of a portion of the cold saw system of FIG. 1A.

FIG. 2 is a side view of a circular saw of a cold saw system, according to an example.

FIG. 3A is a view of a damper of the system of FIGS. 1A-1B.

FIG. 3B is a view of a portion of the damper of FIG. 3A.

FIG. 3C is a view of a portion of the damper of FIGS. 3A-3B.

FIG. 4 is a perspective view of a clamp for a cold saw system, according to an example.

FIG. 5 is a front view of a pneumatic control panel for a cold saw system, according to an example.

FIG. 6 is a perspective view of a portion of an infeed table of the system of FIG. 1A.

FIG. 7A is a side view of an anchor portion of an emergency pull line assembly for a cold saw system, according to an example.

FIG. 7B is a side view of a switch portion of the emergency pull line assembly of FIG. 7A.

FIG. 8 is a perspective view of a controller for a cold saw system, according to an example.

FIG. 9 is a front view of a first user interface of the controller of FIG. 8.

FIG. 10 is a home screen displayed on a display of the first user interface of FIG. 9.

FIG. 11 is a manual movement screen displayed on a display of the first user interface of FIG. 9.

FIGS. 12A-12B are incremental movement screens displayed on a display of the first user interface of FIG. 9.

FIGS. 13A-13D are preset programming screens displayed on a display of the first user interface of FIG. 9.

FIGS. 14A-14C are preset implementation screens displayed on a display of the first user interface of FIG. 9.

FIGS. 15A-15B are calibration screens displayed on a display of the first user interface of FIG. 9.

FIGS. 16A-16M are parts list programming screens displayed on a display of the first user interface of FIG. 9.

FIG. 17 is a saw delay screen displayed on a display of the first user interface of FIG. 9.

FIG. 18 is a clamp delay screen displayed on a display of the first user interface of FIG. 9.

FIG. 19 is a cycle time out screen displayed on a display of the first user interface of FIG. 9.

### DETAILED DESCRIPTION

### Explanation of Terms

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

As used in this disclosure and in the claims, the singular forms “a,” “an,” and “the” include the plural forms unless the context clearly dictates otherwise. Additionally, the term “includes” means “comprises.” Further, the terms “coupled” and “associated” do not exclude the presence of intermediate elements between the coupled or associated items absent specific contrary language.

Although there are alternatives for various components, dimensions, parameters, operating conditions, etc., set forth herein, that does not mean that those alternatives are necessarily equivalent and/or perform equally well. Nor does it mean that the alternatives are listed in a preferred order unless stated otherwise.

### Embodiments of the Disclosed Technology

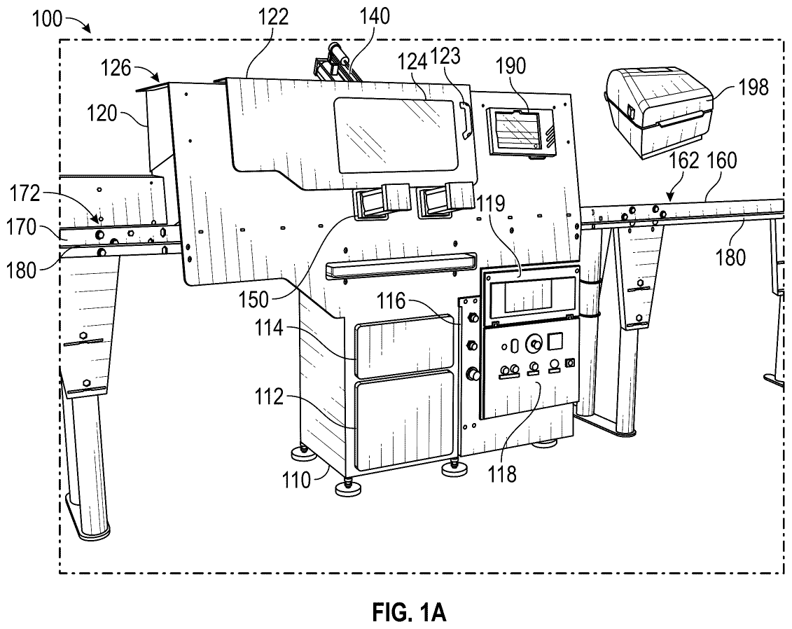

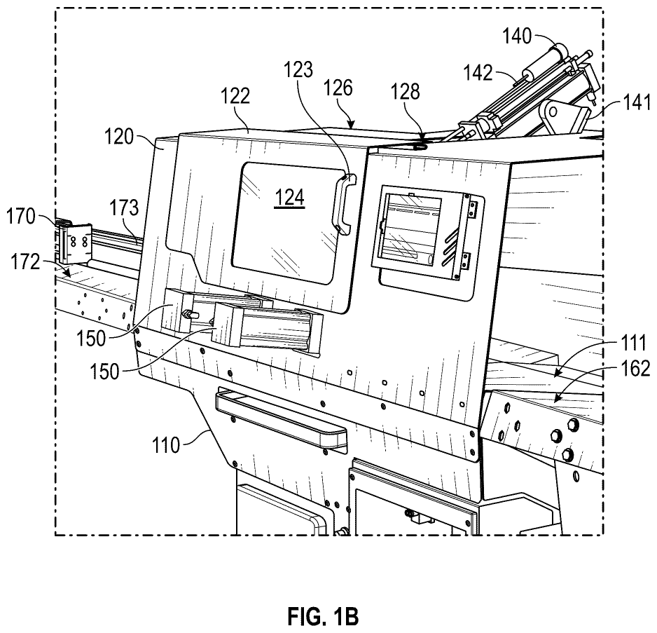

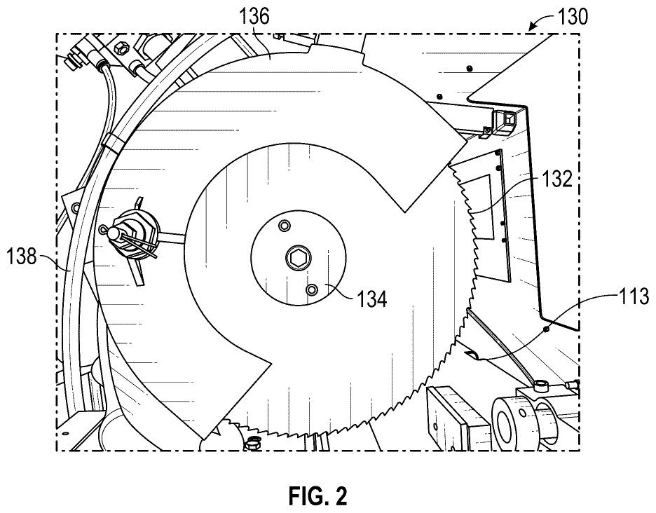

FIGS. 1A-1B are perspective views of a cold saw system 100 for cutting a workpiece (not shown), according to an example. The illustrated cold saw system 100 is configured to cut workpieces made of ferrous metals (for example, carbon steel, stainless steel, steel alloys, an wrought iron). However, in some examples, the cold saw system 100 can be configured to cut workpieces made of non-ferrous metallic materials (for example, aluminum, copper, nickel, zinc, etc.). The cold saw system 100 includes a saw table 110, a saw cabinet 120, a circular saw 130 (best shown in FIG. 2), a damper 140, clamps 150, an infeed table 160, and an outfeed table 170, an emergency pull line assembly 180, and a controller 190.

The saw table 110 is a structure that forms a flat table surface 111 (best shown in FIG. 1B) on which the workpiece rests and is fed into the circular saw. The saw table 110 can serve as a housing for certain components of the cold saw system 100. For example, as shown, the saw table 110 can include a coolant reservoir cabinet 112 for housing a coolant reservoir. The coolant reservoir can hold coolant that is sprayed onto the workpiece during cutting to reduce heat buildup in the workpiece. As shown, the saw table 110 further includes a strainer cabinet 114 for housing a coolant strainer. The coolant strainer can filter out swarf (in other words, debris) from coolant that was sprayed on the workpiece and circular saw, thereby allowing this coolant to be collected in the coolant reservoir and reused.

Referring now to FIG. 2, the saw table 110 includes one or more slots 113 in the table surface 111. The slots 113 can be fluidly coupled to the coolant strainer in the strainer cabinet 114 and can be configured to drain coolant collecting on the table surface 111 into the coolant strainer. In some examples, the table surface 111 can be tilted, curved, or otherwise configured in a way that directs coolant collecting on the table surface 111 toward the slots 113.

Now referring back to FIGS. 1A-1B, the saw table 110 can include controls for operating and/or controlling the cold saw system 100. For example, the saw table 110 can include a pneumatic control panel 116 for controlling pneumatic components of the saw table system 100. For example, the pneumatic control panel 116 can include controls (for example, knobs) for adjusting the speed at which the clamps engage the workpiece and/or the force applied to the workpiece by the clamps. As further shown, the saw table 110 includes a power control panel 118 for adjusting the supply of electrical power to the cold saw system 100. For example, the power control panel 118 can include a power switch, an emergency stop switch. The power control panel 118 can further include indicator lights that provide information on the operational status of the cold saw system 100 and its constituent subsystems. As further shown, the saw table 110 includes an I/O panel 119 that serves as a communications hub for the electromechanical components of the cold saw system 100.

The saw cabinet 120 is an enclosure mounted on the saw table 110. The saw cabinet 120 is configured to fully enclose the circular saw 130 to help prevent the user of the cold saw system 100 from contacting the circular saw 130 during operation. The saw cabinet 120 is also configured to help contain debris (for example, dust or chips), coolant, and noise generated during operation therein, thereby further protecting the user. As shown, the cabinet 120 includes a guard door 122 that, when opened, allows access to the table surface 111 for adjusting the workpiece, maintenance, and cleaning. The guard door 122 includes a handle 123 and a window 124 for viewing the table surface 111 and the workpiece disposed thereon. As further shown, the saw cabinet 120 includes a top surface 126 defining a top portion of the enclosure and an aperture 128 in the top surface 126.

In some examples, the saw cabinet 120 can include a mechanical interlock switch. The mechanical interlock switch can be configured to ensure the safety of a user of the cold saw system 100 by preventing the operation (for example, the rotational and/or positional movement) of the circular saw 130 when the guard door 122 is opened. For example, the mechanical interlock switch can be electrically coupled to the circular saw 130 (for example, via the controller 190 and/or another circuit of the cold saw system 100) such that the circular saw 130 cannot change position when the guard door 122 is opened. Furthermore, the mechanical interlock switch can be electrically coupled to the circular saw 130 in a way that prevents the circular saw 130 from forming a cut, e.g., in a workpiece, when the guard door 122 is opened. Thus, the mechanical interlock switch prevents the circular saw 130 and/or other components of the cold saw system 100 from being activated, used, cycled, moved, etc. when the guard door 122 is not in a position to fully protect the user.

Now referring to FIG. 2, the cold saw system 100 includes the circular saw 130. The circular saw 130 is configured to form a cut in the workpiece. As shown, the circular saw 130 includes a toothed, circular saw blade 132. The saw blade 132 is configured to cut ferrous materials, including but not limited to iron, steel, and steel alloys. In some examples, the saw blade 132 can be made at least partially from high strength steel (HSS) and/or carbide (for example, the blade 132 can include carbide-tipped teeth). In some examples, the saw blade 132 can have a bi-metal construction configured for cutting ferrous materials. As shown, the circular saw 130 further includes a collar 134 for securing the circular saw blade 132 to a shaft. The shaft in turn is coupled to a motor (for example, an electric motor) that generates torque for rotating the circular saw blade 132. The motor can be configured to receive signals via the I/O panel 119. In some examples, the collar 134 can provide additional support for the saw blade 132 to help reduce blade vibration and wobble. The circular saw 130 can further include a blade guard 136 disposed over a portion of the saw blade 132, thereby preventing the saw blade 132 from contacting the user or other components of the cold saw system 100 during operation.

In some examples, the circular saw 130 is moveable between a resting position and a cutting position. In the resting position (best shown in FIG. 2), the circular saw 130 is retracted such that the saw blade 132 cannot engage the workpiece disposed on the table surface 111. In the cutting position (best shown in FIG. 1B), the circular saw 130 is advanced such that the saw blade 132 can contact and/or cut the workpiece disposed on the table surface 111. The cold saw system 100 can include an actuator, including but not limited to any one of a linear actuator, a cam actuator, a screw actuator, and a hydraulic actuator, for moving the circular saw 130 between the resting position and the cutting position. The actuator can be configured to receive signals via the I/O panel 119.

Now referring to FIG. 2, the cold saw system 100 can further include a coolant line 138 for transferring coolant. During operation of the cold saw system 100, coolant can be pumped from the coolant reservoir stored in the coolant reservoir cabinet 112 and out through the coolant line 138 to spray coolant onto the saw blade 132 and/or the workpiece. In some examples, the cold saw system 100 can include a pump fluidly connected to the coolant reservoir and the coolant line 138 for pumping the coolant. In some examples, the cold saw system 100 can include a nozzle for directing the spray of coolant. In some examples, coolant can help reduce friction between the saw blade 132 and the cutting surface of the workpiece, thereby reducing heat buildup in the workpiece.

Now referring back to FIGS. 1A-1B, the cold saw system 100 includes the damper 140, which is configured to regulate the movement of the circular saw 130 relative to the workpiece. As shown, the damper 140 is mounted to the top surface 126 of the saw cabinet 120 using a mount 141, and a portion of the damper 140 extends through the aperture 128 in the top surface 126 and into the enclosure formed by the saw cabinet 120. The circular saw 130, which is disposed within the saw cabinet 120, is coupled to an end portion of the damper 140.

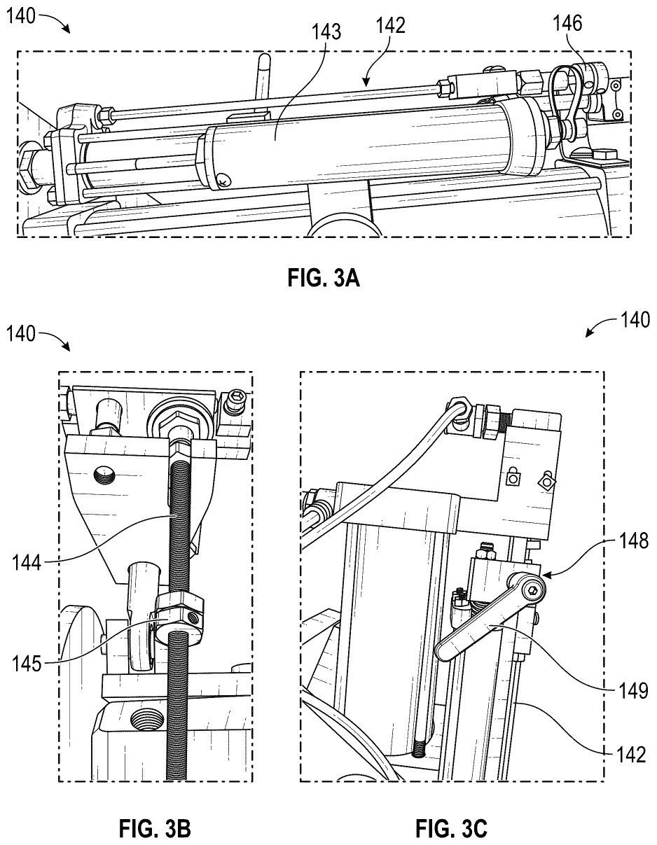

Now referring to FIGS. 3A-3C, the illustrated damper 140 includes a return tube 142. The return tube 142 can include an enclosed reservoir 143 filled at least partially with a fluid (for example, compressed air, oil, etc.), wherein the reservoir 143 is coupled to the mount 141. The return tube 142 can include a rod 144 extending from an end of the reservoir 143. The circular saw 130 can be coupled to the rod 144 such that as the circular saw 130 moves relative to the reservoir 143 and the mount 141 (for example, as the circular saw 130 moves toward or away from the cutting position), the rod 144 forces fluid through an orifice within the return tube 142 to resist the relative movement of the rod 144 (and the corresponding movement of the circular saw 130).

In some examples, the damper 140 is configured not to slow or dampen the movement of the circular saw 130 until the circular saw 130 reaches an intermediate damper activation position disposed between the resting position and cutting position. In such examples, a hard stop bracket can be fixedly coupled to the circular saw 130. The hard stop bracket can be coupled to the rod 144; for example, the rod 144 can seated in a slot or hole in the hard stop bracket.

Now referring to FIG. 3B, the rod 144 can be threaded and one or more nuts 145, which can be screwed onto the rod 144. As the circular saw 130 is advanced from the resting position to the damper activation position, the nuts 145 do not engage the hard stop bracket, thereby allowing the rod 144 to move freely relative to the hard stop bracket (and thus allow the circular saw 130 to move freely relative to the damper 140). Thus, as the circular saw 130 is advanced from the resting position to the damper activation position, the damper 140 does not slow the movement of the circular saw 130. However when the circular saw 130 reaches the damper activation position, the nuts 145 contact and engage the hard stop bracket attached to the circular saw 130 (forcing the circular saw 130, the hard stop bracket, the rod 144, and the nuts 145 to move in unison from the damper activation position to the cutting position). Thus, as the circular saw 130 advances past the damper activation position and to the cutting position, the rod 144 is pushed into the reservoir 143 and forces fluid through a narrow orifice within the reservoir 143, thereby creating resistance to the movement of the circular saw 130 moving in unison with the rod 144. In some examples, the distance between the damper activation position and the cutting position can be approximately one eighth of an inch (⅛″). However, the damper activation position can be increased or decreased by moving the nuts 145 relative to the threaded rod 144.

By only dampening the movement of the circular saw 130 after the circular saw 130 passes the damper activation position, the damper 140 allows the circular saw 130 to be quickly advanced between the resting position and damper activation position to reduce overall cycle time while also ensuring that the down feed rate of the circular saw 130 is sufficiently slow, for example, to reduce heat buildup within the workpiece, to reduce the amount of noise made while cutting the workpiece, and/or to make a higher-quality cut. As used herein, the term “down feed rate” refers to the rate at which the circular saw 130 advances from the damper activation position to the cutting position.

Now referring to FIG. 3A, the damper 140 can include a down feed rate adjustment knob 146 for adjusting the down feed rate of the circular saw 130. In some examples, the down feed rate adjustment knob 146 can be coupled to an actuator (for example, a rotary servomotor or rotary actuator) to allow for the automatic adjustment of the down feed rate. The actuator can be configured to receive commands via the I/O panel 119.

Now referring to FIG. 3C, the damper 140 can include a cutting envelope adjuster 148 for adjusting a cutting envelope of the circular saw 130. As used herein, the term “cutting envelope” refers to the maximum dimension within which the circular saw 130 can cut. The cutting envelope adjuster 148 can include a worm screw (or any other type of linear actuator) coupled to the reservoir 143 of the return tube 142 and a lever 149 coupled to the worm screw. Rotating the lever 149 allows the cutting envelope adjuster 148 to be moved closer to or away from a tool at extension sensor. In some examples, reducing the size of the cutting envelope can help prevent the cold saw system 100 from cutting past the workpiece and thus reduce the amount of time wasted by cutting past the workpiece. In some examples, moving the cutting envelope adjuster 148 closer to the tool at extension sensor can decrease the cutting envelope while moving the cutting envelope adjuster 148 further from the tool at extension sensor can increase the cutting envelope. In some examples, the lever 149 can be replaced with an actuator to allow for the automatic adjustment of the cutting envelope. The actuator can be configured to receive commands via the I/O panel 119.

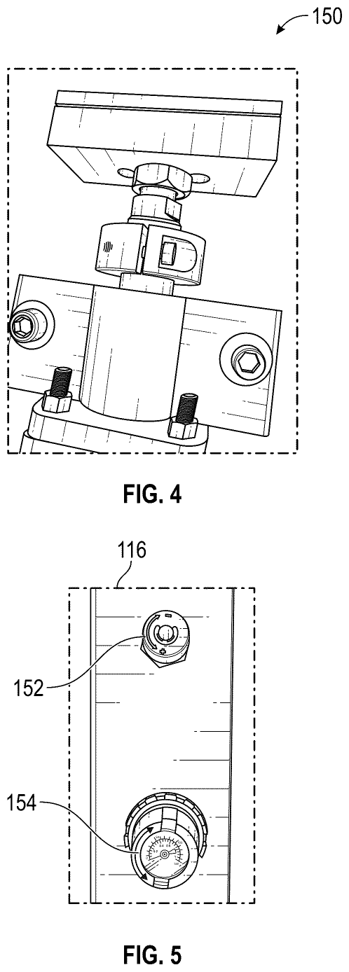

Now referring to FIG. 4, the cold saw system 100 includes at least one clamp 150 configured to releasably engage the workpiece disposed on the table surface 111 of the saw table 110. In some examples, the clamps 150 can be pneumatic clamps that receive compressed air via the pneumatic control panel 116. For example, the pneumatic control panel 116 can be coupled to one or more solenoid valves, which can be fluidly connected to an air supply (for example, an air compressor). The solenoid valves can be fluidly connected to the clamps 150 and can activate or deactivate the clamps 150 by selectively supplying the clamps 150 with pressurized air. The solenoid valves can be configured to receive signals from the I/O panel 119.

Now referring to FIG. 5, the pneumatic control panel 116 can include a clamp speed knob 152 to adjust the speed at which the clamps 150 engage with workpiece and a clamp pressure knob 154 to adjust the force by which the clamps 150 engage the workpiece. In some examples, these knobs 152, 154 can be coupled to actuators to allow for the automatic adjustment of clamp speed and clamp pressure. The actuators can be configured to receive signals from the I/O panel 119.

Referring back to FIGS. 1A-1B, the cold saw system 100 includes two clamps 150 arranged on opposite sides of the circular saw 130. However, the cold saw system 100 can include any number of clamps 150 arranged in any configuration.

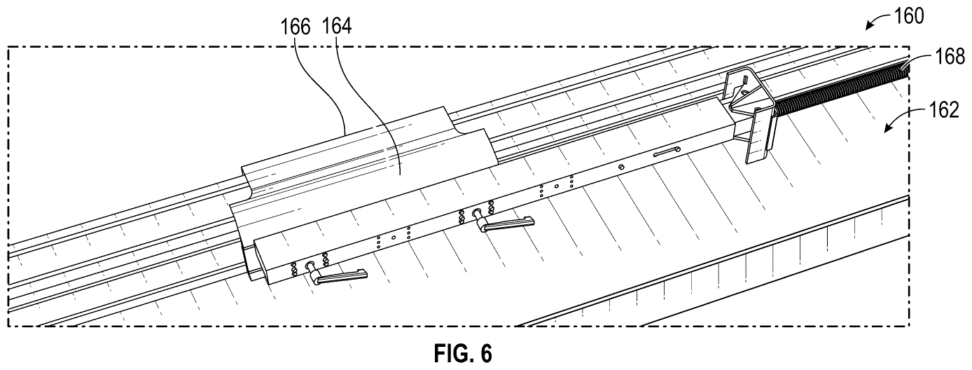

Referring now to FIG. 6, the infeed table 160 can be configured to automatically advance a workpiece toward the cutting saw 130. As shown, the infeed table 160 can include an infeed table surface 162 and a push feeder comprising a push feeder carriage 164 resting on the infeed table surface 162. The outfeed table surface 162 can be coplanar with the table surface 111 of the saw table 110. The push feeder carriage 164 can include a housing 166 and a motor (not shown) disposed within the housing 166. The motor can be configured to propel the push feeder carriage 164 along a length of the infeed table 160. The push feeder is integrated into the cold saw system 100 such that the motor can be controlled based on user input and/or based on a signal from the controller 190. When a workpiece is placed on the infeed table surface 162, the workpiece can be engaged by the push feeder carriage 164 and pushed toward the circular saw 130. In some examples, the infeed table 160 can include a backfence extending from the infeed table surface 162. The backfence of the infeed table 160 can have a similar structure as the backfence 173 of the outfeed table 170 shown in FIG. 1B.

Referring back to FIGS. 1A-1B, the outfeed table 170 can be configured to automatically advance a cut workpiece away from the cutting saw 130. The outfeed table 170 can include an outfeed table surface 172 that is coplanar with the table surface 111 of the saw table 110 and a pull feeder. In some examples, the pull feeder of the outfeed table 170 can include a carriage similar to the push feeder carriage 164 of the infeed table 160. The carriage of the pull feeder can be coupled to the workpiece and configured to pull the workpiece along a length of the outfeed table surface 172. The carriage of the pull feeder can include a motor (similar to the motor of the push feeder carriage 164) to move it along the outfeed table surface 172, and the motor can similarly be controlled by the controller 190. Thus, similar to the push feeder, the pull feeder can be integrated into the cold saw system 100.

Referring back to FIG. 1B, the outfeed table 170 can further include a backfence 173. The backfence 173 can be a structure extending from the outfeed table surface 172. The backfence 173 can be used to align the workpiece as the workpiece travels along a length of the outfeed table surface 172. In some examples, the backfence 173 can be used as a rail along which the carriage of the outfeed table 170 can slide. Still referring to FIG. 1B, in some examples, at least one of the infeed table surface 162 and the outfeed table surface 172 can be tilted at an angle relative to the table surface 111 of the saw table 110 and/or a ground surface upon which the cold saw system rests. For example, as shown in FIG. 1B, the infeed table surface 162 can be tilted at an angle relative to the table surface 111 of the saw table 110 such that a lateral edge of the infeed table surface 162 closer to the backfence is vertically lower than a lateral edge of the infeed table surface 162 further away from the backfence. In some examples, tilting the infeed table surface 162 and/or the outfeed table surface 172 in this manner can help ensure workpieces with rounded shapes stay flush against the backfence (for example, backfence 173) as the workpieces are pushed along the infeed table 160 towards the circular saw 130 and/or pulled along the outfeed table 170 away from the circular saw 130. In some examples, each one of the table surface 111, the infeed table surface 162, and the outfeed table surface 172 can be tilted at an angle (for example, the same angle) relative to the ground surface.

Referring now to FIGS. 1A-1B, the cold saw system 100 can include an emergency pull line assembly 180 configured to stop the cold saw system 100 in case of an emergency. The emergency pull line assembly 180 can be configured to protect the user in areas where material is being loaded or unloaded. The emergency pull line assembly 180 can include a pull line 182 extending along a length of at least one of the infeed table 160 and the outfeed table 170. In some examples, the pull line 182 can extend along the entire length of at least one of the infeed table 160 and the outfeed table 170. As shown, the cold saw system 100 can include an emergency pull line assembly 180 with a first pull line 182 extending along the entire length of the infeed table 160 and a second emergency pull line assembly 180 with a second pull line 182 extending along the entire length of the outfeed table 170. When either pull line 182 is pulled by a user of the cold saw system 100, the cold saw system 100 automatically halts the motor coupled to the saw blade 132 and stops the movement of the damper 140, thereby stopping the rotational and positional movement of the circular saw 130 to ensure the safe cessation of operation of the cold saw system 100.

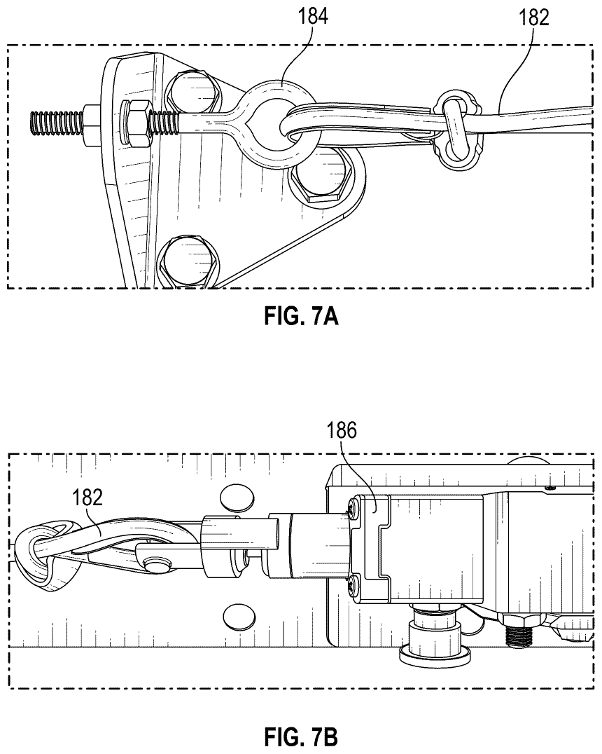

Now referring to FIGS. 7A-7B, each emergency pull line assembly 180 includes the pull line 182 anchored at a first end to an emergency pull line anchor 184 and anchored at a second end to an emergency pull line switch 186. In some examples, each emergency pull line switch 186 can be coupled to the I/O panel 119. In some examples, the emergency pull line switches 185 can be coupled to a circuit separate from the I/O panel 119. For example, each emergency pull line switch 185 can be coupled to a corresponding independent circuit, and each independent circuit can be configured to stop the movement of the circular saw 130. In some examples, coupling each emergency pull line switch 185 to its own independent circuit can beneficially increase the redundancy of the safety features of the cold saw system 100 in case one of the emergency pull line switches 185 and/or its corresponding independent circuit fails.

Now referring back to FIGS. 1A-1B, the cold saw system 100 includes a controller 190 configured to send commands to the electromechanical components of the cold saw system 100. As shown, the controller 190 is coupled to the saw cabinet 120. However, the controller 190 can be disposed on any portion of the cold saw system 100.

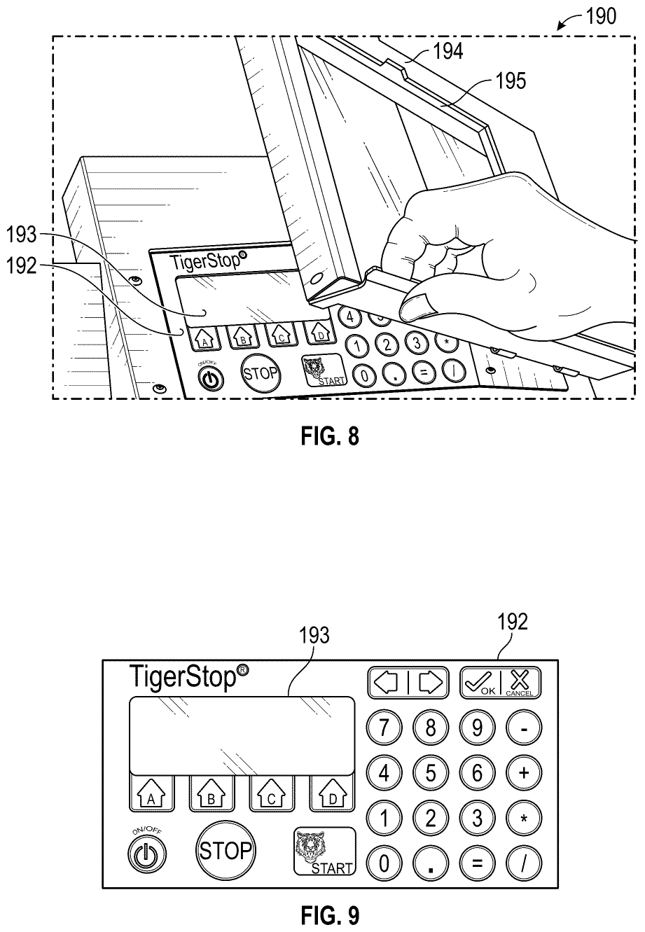

Now referring to FIGS. 8-9, the controller 190 can include a first user interface 192 and a second user interface 194. As shown, the first user interface 192 includes a non-touchscreen display 193 and the second user interface 194 includes a touchscreen display 195. In some examples, the second user interface 194 can be an optional upgrade for the cold saw system 100. However, the controller 190 can include any number of touchscreen interfaces and non-touchscreen interfaces in any combination.

As further shown, the second user interface 194 can be hingedly coupled to the first user interface 192, and can be moved between a closed position and an open position relative to the first user interface 192. When the second user interface 194 is in the closed position, the second user interface 194 can cover the first user interface 192. The first user interface 192 and the second user interface 194 can face the same direction (for example, toward the user) when the second user interface 194 is in the closed position. When the second user interface 194 is in the open position, the user can access the first user interface 192. In this way, the first user interface 192 and the second user interface 194 can both be accessible to the user without increasing the footprint of the controller 190 on the saw cabinet 120.

The controller 190 can be any computing unit and/or device that includes a processor and a memory. In some examples, the processor can be an integrated circuit, an application specific integrated circuit (ASIC), a digital signal processor (DSP), a field programmable gate array (FPGA), a programmable logic controller (PLC), and/or any combination thereof designed to perform the functions described herein. In some examples, the memory can be a non-transitory memory configured to store instructions that are executable by the processor. In some examples, the controller 190 can comprises a plurality of computing units. For example, the first user interface 192 and the second user interface 194 can be separate computing devices. In some examples, the functionality of the controller 190 can be divided among the plurality of computing units (for example, divided between the first user interface 192 and the second user interface 194). In some examples, each of the first user interface 192 and the second user interface 194 can possess the entire functionality of the controller 190; in other words, the first and second user interfaces 192, 194 can be redundant. In some examples, the redundant second user interface 194 can be an optional upgrade that is added to at least partially replace the first user interface 192 to add touch screen functionality to the cold saw system 100. In some examples, the plurality of computing units can communicate with each other over a wired or wireless connection.

The controller 190 can send signals to the electromechanical components of the cold saw system 100 connected to the I/O panel 119, thereby allowing for automatic operation of the cold saw system 100. For example, memory of the controller 190 can store instructions that, when executed, cause the cold saw system 100 to perform a cutting action that forms a cut in the workpiece. The cutting action can include moving the workpiece into place via a positioner (for example, the push feeder carriage 164 of the infeed table 160 and/or the carriage of the outfeed table 170), engaging the workpiece with the clamps 150, activating the coolant pump to spray coolant onto the workpiece and/or the saw blade 132, activating the circular saw 130 to begin rotation of the saw blade 132, advancing the circular saw 130 from the resting position to the cutting position, retracting the circular saw 130 from the cutting position to the resting position, deactivating the circular saw 130 to stop rotation of the saw blade 132, deactivating the coolant pump, and disengaging the clamps 150 from the workpiece.

In some examples, one or more sensors can be connected to the controller 190 (for example, via the I/O panel 119). For example, the cold saw system 100 can include a tool position sensor that detects the position of the circular saw 130. For example, the tool position sensor can detect whether the circular saw 130 is at rest in the resting position or at extension in the cutting position.

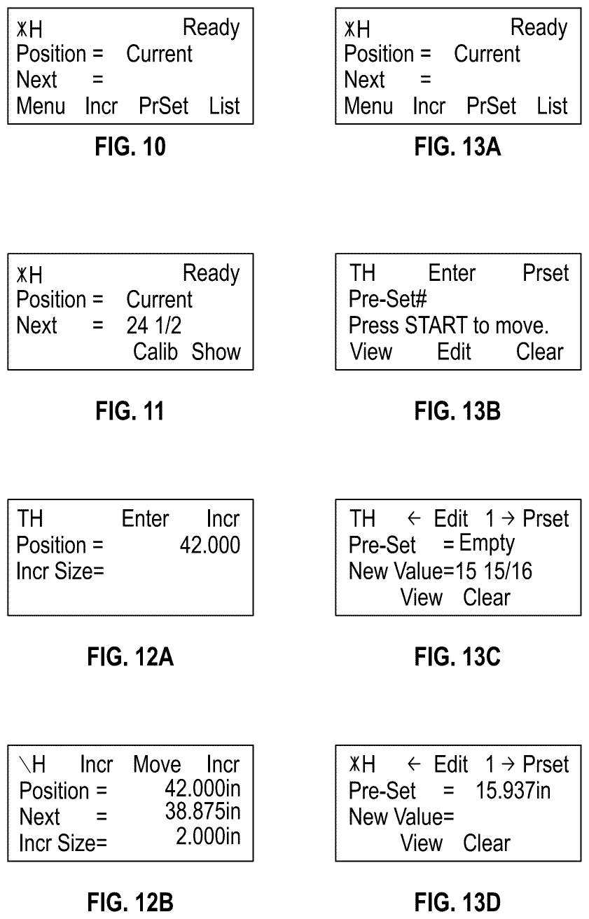

FIG. 10 is a ready screen displayed on the display 193 of the first user interface 192. The ready screen can be the initial screen or default screen shown on the display 193.

FIG. 11 is a manual movement screen displayed on the display 193 of the first user interface 192. The controller 190 can have a manual movement functionality to move a workpiece on the table surface 111 of the saw table 110. For example, the user can enter a manual movement length by which to move the workpiece on the table surface 111 of the saw table 110 relative to the circular saw 130. As shown the manual movement length can be entered as a fractional value (for example twenty four and one half inches would be entered as “24 ½”). However, in some examples, the manual movement length can be entered as a decimal value (for example “24.5”). Any length described herein, not just the manual movement length, can be entered into the controller 190 as either a fractional or decimal value. Upon receiving the length input by the user, the controller 190 can actuate the clamps 150, the push feeder carriage 164 of the infeed table 160, and/or the pull feeder of the outfeed table 170 to move the workpiece by the length.

FIGS. 12A-12B are incremental movement screens displayed on the display 193 of the first user interface 192. The controller can have an incremental movement functionality to repeatedly move the workplace by an increment length. As shown in FIG. 12A, the user can press an increment button (Incr) and enter the increment length, for example, 42.000 inches. As shown in FIG. 12B, each time the user presses a button, the workpiece is moved by the increment length. The incremental movement screen can display the current position, the next position, and the increment length.

FIGS. 13A-13D are preset programming screens displayed on the display 193 of the first user interface 192. The controller 190 can have a preset functionality that stores a preset length in the memory of the controller 190 and moves the workpiece by the preset length. FIGS. 13A-13D show how the user can add or update a preset length using the first user interface 192. For example, the user can press a preset key (PrSet) to access the preset feature (FIG. 13A). The user can then enter a preset number to program corresponding to the desired preset (FIG. 13B), enter a preset length for the desired preset as either a decimal or fraction value (FIG. 13C), and save the mapping of the preset length to the preset number in the controller's memory (FIG. 13D).

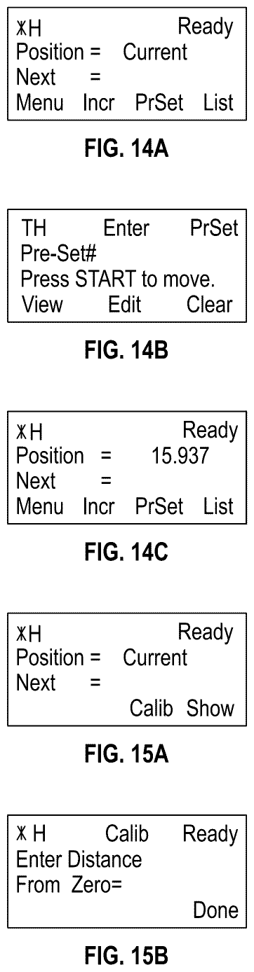

FIGS. 14A-14C are preset implementation screens displayed on the display 193 of the first user interface 192, showing how the user can use the preset functionality to move the workpiece by a preset length. The user can press the preset key (PrSet) (FIG. 14A), enter a preset program number to set a length (for example, the manual movement length or the increment length) equal to the desired preset length (FIG. 14B), and the workpiece will move to the preset length (FIG. 14C).

FIGS. 15A-15B are calibration screens displayed on the display 193 of the first user interface 192. The controller 190 can feature a quick calibration functionality that allows the cold saw system 100 to be quickly calibrated. During the quick calibration process, a workpiece is cut and measured by the user. The user can press a calibration key (Calib) (FIG. 15A) and then enter the measured length of the workpiece to calibrate the position of the stop to the measured length (FIG. 15B).

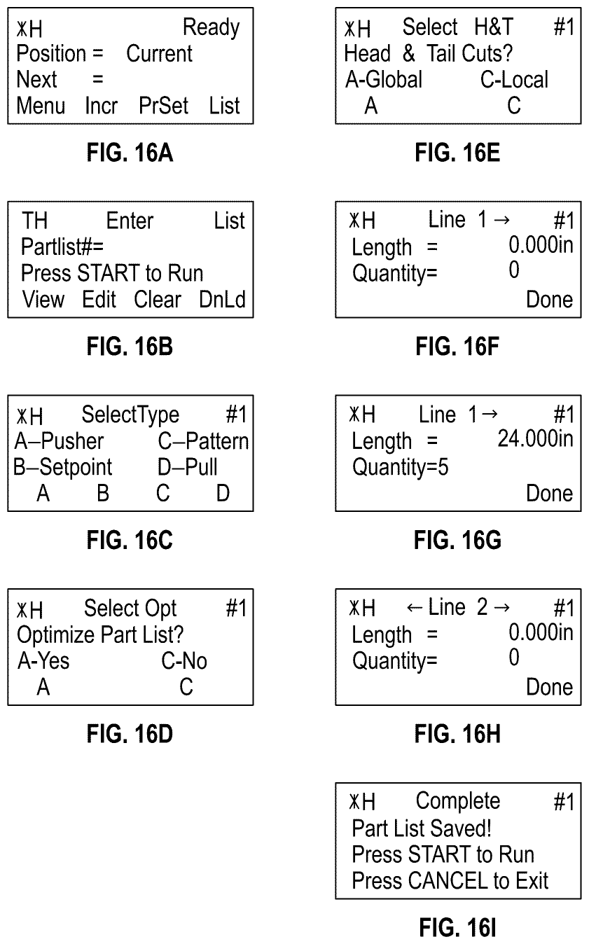

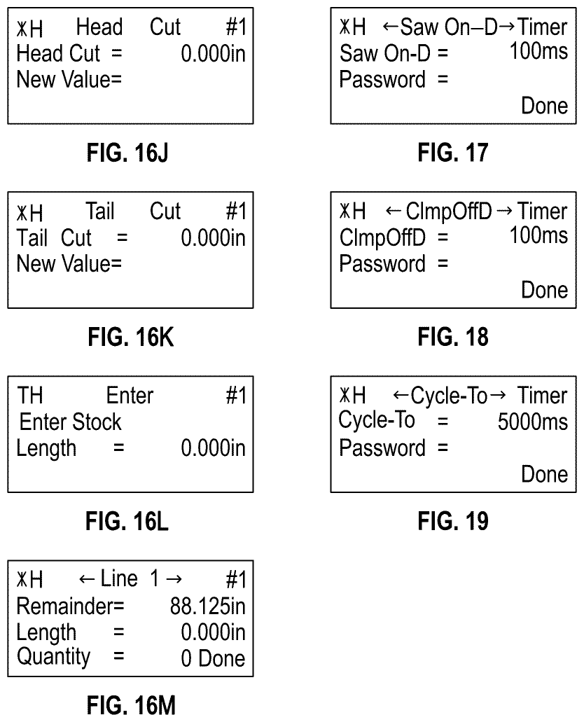

FIGS. 16A-16M are parts list screens displayed on the display 193 of the first user interface 192. The controller 190 can have a part list functionality, which allows the cold saw system 100 to automatically make one or more cuts in a desired workpiece to form a part. To program a part list, a user can press a list key (List) (FIG. 16A) and enter a list number to program (FIG. 16B). The user can then select which type of part list corresponds to the list number: a pusher list, a setpoint list, a pattern list, or a pull list (FIG. 16C).

The pusher list can be a list of instructions that command the cold saw system 100 to push a workpiece (for example, stock material) into the cold saw system 100, treating each length of the pusher list as an incremental movement.

The set point list can be a list of instructions that command the cold saw system to move a workpiece by an absolute value from a set point.

The pattern list can be a list of instructions for pushing stock material into the cold saw system 100 in a push-feed fashion to form parts out of the stock material. In some examples, the cold saw system 100 can be configured to repeat the pattern list a predetermined number of times. In some examples where the predetermined number of times is a user-defined number of times, the cold saw system 100 can prompt a user to enter the number of times the pattern list should be repeated, for example, via the first user interface 192 and/or the second user interface 194. In some examples, the cold saw system 100 can additionally or alternatively be configured to repeat the pattern list until it receives an instruction to stop. For example, the cold saw system 100 can be configured to repeat the pattern list until the controller 190 receives a command from the user via the first user interface 192 and/or the second user interface 194.

The pull list can be a list of instructions that pull stock material out of the cold saw system 100 in a pull-feed fashion. In some examples, the cold saw system 100 can be configured to repeat the pull list a predetermined number of times. In some examples, the predetermined number of times can be the user-defined number of times entered by the user via the first user interface 192 and/or the second user interface 194. In some examples, the cold saw system 100 can additionally or alternatively be configured to repeat the pull list until it receives an instruction to stop, for example, an instruction entered by the user via the first user interface 192 and/or the second user interface 194.

To program a pusher list or set point list, the user can then select whether the part list should be optimized for maximum material yield (FIG. 16D). The user can then select whether to use a global head and tail cut setting stored in the memory of the controller 190 or a local head and tail cut setting entered by the user for only the current part list (FIG. 16E). The user can then enter a desired length of the part (FIG. 16F) and the number of parts to process at the desired length (FIG. 16G). The user can enter additional lengths of additional parts to process (FIG. 16H) and then save the part list (FIG. 16I).

To program a pattern list or pull list, instead of programming the controller 190 as shown in FIGS. 16D-16H, the user instead enters a head cut value (FIG. 16J), a tail cut value (FIG. 16K), a stock length (FIG. 16L), and a length of the part to process (FIG. 16M). The user can enter subsequent parts to the pattern or pull list in the same screen (FIG. 16M) and then save the part list (FIG. 16I). In some examples, the controller 190 can restrict the user to entering part lengths and quantities that are less than or equal to a stock length of the material being fed into the cold saw system 100, minus a head cut and a tail cut. This can beneficially allow the controller 190 to restrict the user from attempting to cut too many parts from the material.

FIG. 17 is a saw on delay screen displayed on the display 193 of the first user interface 192. The controller 190 can have a saw on delay functionality that implements a time delay between the time the clamp 150 is activated and the time the circular saw 130 is activated and/or begins advancing from the resting position. In some examples, the saw delay can be approximately 100 milliseconds. In some examples, the saw on delay can beneficially ensure that the workpiece is clamped before the circular saw 130 is activated.

FIG. 18 is a clamp delay screen displayed on the display 193 of the first user interface 192. The controller 190 can have a clamp delay functionality that implements a time delay between the time a sensor (for example, a tool at rest sensor) detects that the circular saw 130 has returned to the resting position and the time that the clamp 150 disengages the workpiece. In some examples, the clamp off delay can be approximately 100 milliseconds. In some examples, a clamp delay can beneficially ensure that the circular saw 130 has fully disengaged the workpiece before the clamp 150 is released.

FIG. 19 is a cycle time out screen displayed on the display 193 of the first user interface 192. The controller 190 can have a cycle time out functionality to set a maximum cycle time for a cutting action. In some examples, the cycle time out can be approximately 5000 milliseconds. In some examples, the cycle time out functionality can beneficially ensure that the cycle time can be adjusted to allow for the cutting of workpieces of different thicknesses.

Now referring back to FIG. 1A, the cold saw system 100 can include a label printer 198. The label printer 198 can be configured to print out labels to affix to cut workpieces. In some examples, the label printer 198 can print a label for each cut workpiece. The label printer 198 can be configured to receive instructions to print labels from the controller 190 via the I/O panel 119.

One advantage of the disclosed cold saw system 100 over the prior art is that the cold saw system 100 is an integrated system including the circular saw 130, the damper 140, the infeed table 160, and the outfeed table 170 co-operating with each other. Since these components can all be centrally controlled, e.g., by the controller 190, the cutting actions performed by the circular saw 130 and the damper 140 can be coordinated with the material handling actions performed by the positioner on the infeed table and outfeed tables.

### Examples of the Disclosed Technology

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. A system can include a saw table defining a table surface; a saw cabinet mounted on the saw table, wherein the saw cabinet can include a top surface and an aperture in the top surface; a damper extending at least partially through the aperture; a circular saw coupled to the damper and disposed within the saw cabinet; a clamp configured to releasably engage a workpiece disposed on the table surface of the saw table; at least one of an infeed table defining an infeed table surface, wherein the infeed table surface can be coplanar with the table surface of the saw table, and an outfeed table defining an outfeed table surface, wherein the outfeed table surface can be coplanar with the table surface of the saw table; and a controller storing instructions in non-transitory memory that, when executed, can cause the controller to: engage the clamp; advance the circular saw from a resting position to a cutting position; retract the circular saw from the cutting position to the resting position; and disengage the clamp.

Example 2. The system of any example herein, particularly Example 1, wherein advancing the circular saw from the resting position to the cutting position can include advancing the circular saw past a damper activation position, and wherein advancing the circular saw past the damper activation position engages the damper.

Example 3. The system of any example herein, particularly Example 2, wherein: the circular saw can be advanced at a first rate between the resting position and the damper activation position, the circular saw can be advanced at a second rate between the damper activation position and the cutting position, and wherein the first rate can be greater than the second rate.

Example 4. The system of any example herein, particularly any one of Examples 2-3, wherein the damper can include a threaded rod and a nut coupled to the threaded rod, wherein moving the nut relative to the threaded rod can change a location of the damper activation position.

Example 5. The system of any example herein, particularly any one of Examples 1-4, wherein the saw cabinet can be configured to prevent a user from reaching the circular saw when the system is in operation.

Example 6. The system of any example herein, particularly any one of Examples 1-5, wherein the system can be configured to rest upon a ground surface, and wherein at least one of the infeed table surface and the outfeed table surface can be tilted relative to the ground surface.

Example 7. The system of any example herein, particularly any one of Examples 1-6, which can further include an emergency pull line assembly, wherein: the emergency pull line assembly can include a pull line extending along a length of one of the infeed table and the outfeed table, and the emergency pull line assembly can be configured to stop the operation of the system when the pull line is pulled.

Example 8. The system of any example herein, particularly any one of Examples 1-7, wherein: the saw table can include a slot in the table surface, a coolant strainer fluidly coupled to the slot, and a coolant reservoir fluidly coupled to the coolant strainer, and the system can further include a nozzle fluidly coupled to the coolant reservoir and configured to spray coolant onto at least the circular saw.

Example 9. The system of any example herein, particularly any one of Examples 1-8, wherein the saw cabinet can include a guard door and a mechanical interlock switch configured to prevent the operation of the circular saw when the guard door is open.

Example 10. The system of any example herein, particularly any one of Examples 1-9, wherein the infeed table can include a push feeder with a push feeder carriage and a motor coupled to the controller, and wherein the controller can store instructions in non-transitory memory that, when executed, cause the push feeder to advance along a length of the infeed table.

Example 11. A system can include a saw table defining a table surface; a saw cabinet coupled to the saw table; a damper coupled to the saw cabinet; a circular saw coupled to the damper and disposed within the saw cabinet; and a controller storing instructions in non-transitory memory that, when executed, can cause the controller to: advance the circular saw from a resting position to a damper activation position; and advance the circular saw from the damper activation position to a cutting position.

Example 12. The system of any example herein, particularly Example 11, wherein advancing the circular saw from the resting position to the damper activation position can include advancing the circular saw at a first rate, and wherein advancing the circular saw from the damper activation position to the cutting position can include advancing the circular saw at a second rate.

Example 13. The system of any example herein, particularly Example 12, wherein the first rate can be greater than the second rate.

Example 14. A system can include a saw table defining a table surface; a saw cabinet coupled to the saw table; a damper coupled to the saw cabinet; a circular saw coupled to the damper and disposed within the saw cabinet; and a controller storing instructions in non-transitory memory that, when executed, can cause the controller to: advance the circular saw from a resting position to an intermediate position at a first rate; advance the circular saw from the intermediate position to a cutting position at a second rate; and retract the circular saw from the cutting position to the resting position.

Example 15. The system of any example herein, particularly Example 14, which can further include a clamp configured to releasably engage a workpiece disposed on the table surface of the saw table.

Example 16. The system of any example herein, particularly Example 15, wherein the controller can store further instructions in non-transitory memory that, when executed, can cause the controller to: receive a saw on delay; engage the clamp; and activate the circular saw once the saw on delay has elapsed.

Example 17. The system of any example herein, particularly any one of Examples 15-16, which can further a sensor configured to detect whether the circular saw is in the resting position, wherein the controller can store further instructions in non-transitory memory that, when executed, can cause the controller to: receive a clamp off delay; receive a signal from the sensor indicating that the circular saw has been retracted to the resting position; and disengage the clamp after the clamp off delay has elapsed.

Example 18. The system of any example herein, particularly any one of Examples 14-17, wherein the controller can store further instructions in non-transitory memory that, when executed, can cause the controller to receive a part list comprising one or more instructions to operate the circular saw to make a cut in material.

Example 19. The system of any example herein, particularly Example 18, wherein the part list can be one of a pusher list, a set point list, a pattern list, and a pull list.

Example 20. The system of any example herein, particularly any one of Examples 14-19, wherein the controller can include a first user interface and a second user interface, wherein the second user interface is configured to cover the first user interface.

Example 21. The system of any example herein, particularly any one of Examples 14-20, wherein the circular saw can be configured to cut a ferrous material.

The features described herein with regard to any example can be combined with other features described in any one or more of the other examples, unless otherwise stated. For example, any one or more of the features of one cold saw system can be combined with any one or more features of another cold saw system.

In view of the many possible ways in which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and their equivalents.

1. A system comprising:
a saw table defining a table surface;
a saw cabinet mounted on the saw table, wherein the saw cabinet comprises a top surface and an aperture in the top surface;
a damper extending at least partially through the aperture;
a circular saw coupled to the damper and disposed within the saw cabinet;
a clamp configured to releasably engage a workpiece disposed on the table surface of the saw table;
at least one of:
an infeed table defining an infeed table surface, wherein the infeed table surface is coplanar with the table surface of the saw table;
an outfeed table defining an outfeed table surface, wherein the outfeed table surface is coplanar with the table surface of the saw table; and
a controller storing instructions in non-transitory memory that, when executed, cause the controller to:
engage the clamp;
advance the circular saw from a resting position to a cutting position;
retract the circular saw from the cutting position to the resting position; and
disengage the clamp.

2. The system of claim 1, wherein advancing the circular saw from the resting position to the cutting position comprises advancing the circular saw past a damper activation position, and wherein advancing the circular saw past the damper activation position engages the damper.

3. The system of claim 2, wherein:
the circular saw is advanced at a first rate between the resting position and the damper activation position,
the circular saw is advanced at a second rate between the damper activation position and the cutting position, and
wherein the first rate is greater than the second rate.

4. The system of claim 2, wherein the damper comprises a threaded rod and a nut coupled to the threaded rod, wherein moving the nut relative to the threaded rod changes a location of the damper activation position.

5. The system of claim 1, wherein the saw cabinet is configured to prevent a user from reaching the circular saw when the system is in operation.

6. The system of claim 1, wherein the system is configured to rest upon a ground surface, and wherein at least one of the infeed table surface and the outfeed table surface is tilted relative to the ground surface.

7. The system of claim 1, further comprising an emergency pull line assembly, wherein:
the emergency pull line assembly comprises a pull line extending along a length of one of the infeed table and the outfeed table, and
the emergency pull line assembly is configured to stop the operation of the system when the pull line is pulled.

8. The system of claim 1, wherein:
the saw table comprises a slot in the table surface, a coolant strainer fluidly coupled to the slot, and a coolant reservoir fluidly coupled to the coolant strainer, and
the system further comprises a nozzle fluidly coupled to the coolant reservoir and configured to spray coolant onto at least the circular saw.

9. The system of claim 1, wherein the saw cabinet comprises a guard door and a mechanical interlock switch configured to prevent the operation of the circular saw when the guard door is open.

10. The system of claim 1, wherein the infeed table comprises a push feeder comprising a push feeder carriage and a motor coupled to the controller, and wherein the controller stores instructions in non-transitory memory that, when executed, cause the push feeder to advance along a length of the infeed table and position the stock piece accurately to prescribed lengths with repeatable tight tolerances.

11. A system comprising:
a saw table defining a table surface;
a saw cabinet coupled to the saw table;
a damper coupled to the saw cabinet;
a circular saw coupled to the damper and disposed within the saw cabinet; and
a controller storing instructions in non-transitory memory that, when executed, cause the controller to:
advance the circular saw from a resting position to a damper activation position; and
advance the circular saw from the damper activation position to a cutting position.

12. The system of claim 11, wherein advancing the circular saw from the resting position to the damper activation position comprises advancing the circular saw at a first rate, and wherein advancing the circular saw from the damper activation position to the cutting position comprises advancing the circular saw at a second rate.

13. The system of claim 12, wherein the first rate is greater than the second rate.

14. A system comprising:
a saw table defining a table surface;
a saw cabinet coupled to the saw table;
a damper coupled to the saw cabinet;
a circular saw coupled to the damper and disposed within the saw cabinet; and
a controller storing instructions in non-transitory memory that, when executed, cause the controller to:
advance the circular saw from a resting position to an intermediate position at a first rate;
advance the circular saw from the intermediate position to a cutting position at a second rate; and
retract the circular saw from the cutting position to the resting position.

15. The system of claim 14, further comprising a clamp configured to releasably engage a workpiece disposed on the table surface of the saw table.

16. The system of claim 15, wherein the controller stores further instructions in non-transitory memory that, when executed, cause the controller to:
receive a saw on delay;
engage the clamp; and
activate the circular saw once the saw on delay has elapsed.

17. The system of claim 15, further comprising a sensor configured to detect whether the circular saw is in the resting position, wherein the controller stores further instructions in non-transitory memory that, when executed, cause the controller to:
receive a clamp off delay;
receive a signal from the sensor indicating that the circular saw has been retracted to the resting position; and
disengage the clamp after the clamp off delay has elapsed.

18. The system of claim 16, wherein the controller stores further instructions in non-transitory memory that, when executed, cause the controller to receive a part list comprising one or more instructions to operate the circular saw to make a cut in material.

19. The system of claim 18, wherein the part list is one of a pusher list, a set point list, a pattern list, and a pull list.

20. The system of claim 14, wherein the controller comprises a first user interface and a second user interface, wherein the second user interface is configured to cover the first user interface.

21. The system of claim 14, wherein the circular saw is configured to cut a ferrous material.
